(19) United States
(12) Patent Application Publication
(10) Pub. No.: US 2025/0337673 A1
(43) Pub. Date: Oct. 30, 2025

(54) DETECTION DEVICE AND DETECTION METHOD

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(72) Inventors: Kyosuke MASUKAWA, Osaka-shi, Osaka (JP); Hiroyuki TSUKAMOTO, Osaka-shi, Osaka (JP); Takanori MIYOSHI, Osaka-shi, Osaka (JP); Hiroshi UEDA, Yokkaichi-shi, Mie (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP)

(21) Appl. No.: 18/855,390

(22) PCT Filed: Dec. 16, 2022
(86) PCT No.: PCT/JP2022/046331

§ 371 Date: Oct. 9, 2024

(30) Foreign Application Priority Data
Apr. 12, 2022 (JP) 2022-065792

(51) Int. Cl. H04L 43/0852; H04L 41/0631; H04L 43/16

(52) U.S. Cl. CPC H04L 43/0852; H04L 41/0631; H04L 43/16

(57) ABSTRACT

A detection device includes: a calculation unit configured to calculate reception intervals of the target messages; a detection unit configured to perform a detection process based on the reception intervals; and a counting unit configured to count a plurality of burst messages including a delay message that is a target message whose reception interval is larger than the transmission cycle by a predetermined value or more, and one or more target messages which are received subsequently to the delay message and whose reception interval is equal to or smaller than a predetermined value. The detection unit, based on a count value obtained by the counting unit, determines whether or not to perform the detection process based on the reception intervals, for at least one burst message among the plurality of burst messages.

### TECHNICAL FIELD

The present disclosure relates to a detection device and a detection method. This application claims priority on Japanese Patent Application No. 2022-65792 filed on Apr. 12, 2022, the entire content of which is incorporated herein by reference.

### BACKGROUND ART

PATENT LITERATURE 1 (International Publication No. WO2021/111685) discloses a detection device as follows. That is, the detection device is a device for detecting an unauthorized message in an in-vehicle network, and includes: an acquisition unit that acquires a target distribution that is a distribution of reception intervals of periodic messages transmitted in the in-vehicle network; an extraction unit that extracts a part of the target distribution acquired by the acquisition unit, in accordance with a predetermined criterion; and a detection unit that performs a detection process of detecting the unauthorized message, based on the part, of the target distribution, extracted by the extraction unit.

### CITATION LIST

### Patent Literature

PATENT LITERATURE 1: International Publication No. WO2021/111685

### SUMMARY OF THE INVENTION

A detection device of the present disclosure is a detection device that detects an abnormality in a network in which a plurality of target messages, including a periodic message being transmitted and received in a predetermined transmission cycle, are transmitted and received. The detection device includes: a calculation unit configured to calculate reception intervals of the target messages; a detection unit configured to perform a detection process of detecting an abnormality in the network, based on the reception intervals calculated by the calculation unit; and a counting unit configured to count a plurality of burst messages including a delay message that is a target message whose reception interval is larger than the transmission cycle by a predetermined value or more, and one or more target messages which are received subsequently to the delay message and whose reception interval is equal to or smaller than a predetermined value. The detection unit, based on a count value obtained by the counting unit, determines whether or not to perform the detection process based on the reception intervals, for at least one burst message among the plurality of burst messages.

A detection method of the present disclosure is a detection method used in a detection device that detects an abnormality in a network in which a plurality of target messages, including a periodic message being transmitted and received in a predetermined transmission cycle, are transmitted and received. The detection method includes: calculating reception intervals of the target messages; performing a detection process of detecting an abnormality in the network, based on the calculated reception intervals; and counting a plurality of burst messages including a delay message that is a target message whose reception interval is larger than the transmission cycle by a predetermined value or more, and one or more target messages which are received subsequently to the delay message and whose reception interval is equal to or smaller than a predetermined value. In performing the detection process, whether or not to perform the detection process based on the reception intervals is determined for at least one burst message among the plurality of burst messages, based on a count value of the plurality of burst messages.

An aspect of the present disclosure can be realized not only as a detection device including such a characteristic processing unit, but also as a program for causing a computer to execute steps of such characteristic processing, as a semiconductor integrated circuit that realizes a part or the entirety of the detection device, or as a system that includes the detection device.

### BRIEF DESCRIPTION OF DRAWINGS

FIG. 1 shows a configuration of a communication system according to an embodiment of the present disclosure.

FIG. 2 shows a configuration of a relay device according to the embodiment of the present disclosure.

FIG. 3 shows an example of target messages received by the relay device according to the embodiment of the present disclosure, and a distribution of reception times.

FIG. 4 shows an example of statistic values used for a detection process in the relay device according to the embodiment of the present disclosure.

FIG. 5 shows another example of target messages received by the relay device according to the embodiment of the present disclosure, and a distribution of reception times.

FIG. 6 shows an example of statistic values used for a detection process in a relay device according to a comparative example of the embodiment of the present disclosure.

FIG. 7 shows an example of reception times of target messages received by the relay device according to the embodiment of the present disclosure.

FIG. 8 shows another example of reception times of target messages received by the relay device according to the embodiment of the present disclosure.

FIG. 9 shows an example of reception times of target messages received by the relay device according to the embodiment of the present disclosure.

FIG. 10 shows another example of reception times of target messages received by the relay device according to the embodiment of the present disclosure.

FIG. 11 shows an example of reception times of target messages received by the relay device according to the embodiment of the present disclosure.

FIG. 12 shows an example of a correspondence table stored in a storage unit in the relay device according to the embodiment of the present disclosure.

FIG. 13 is a flowchart showing an example of an operation procedure when the relay device according to the embodiment of the present disclosure performs a detection process.

FIG. 14 is a flowchart showing an example of an operation procedure when the relay device according to the embodiment of the present disclosure performs a burst message counting process.

FIG. 15 shows an example of a connection topology of a network according to the embodiment of the present disclosure.

FIG. 16 shows another example of the correspondence table stored in the storage unit in the relay device according to the embodiment of the present disclosure.

### DESCRIPTION OF EMBODIMENTS

To date, a technology for improving security in a network has been proposed.

### Problems to be Solved by the Present Disclosure

A technology enabling more accurate detection of an abnormality in a network is desired beyond the technology described in PATENT LITERATURE 1.

The present disclosure has been made to solve the above problem, and an object of the present disclosure is to provide a detection device and a detection method capable of more accurately detecting an abnormality in a network.

### Effects of the Present Disclosure

According to the present disclosure, it is possible to more accurately detect an abnormality in a network.

### DESCRIPTION OF EMBODIMENT OF THE PRESENT DISCLOSURE

First, contents of the embodiment of the present disclosure will be listed and described.

(1) A detection device according to an embodiment of the present disclosure is a detection device that detects an abnormality in a network in which a plurality of target messages, including a periodic message being transmitted and received in a predetermined transmission cycle, are transmitted and received. The detection device includes: a calculation unit configured to calculate reception intervals of the target messages; a detection unit configured to perform a detection process of detecting an abnormality in the network, based on the reception intervals calculated by the calculation unit; and a counting unit configured to count a plurality of burst messages including a delay message that is a target message whose reception interval is larger than the transmission cycle by a predetermined value or more, and one or more target messages which are received subsequently to the delay message and whose reception interval is equal to or smaller than a predetermined value. The detection unit, based on a count value obtained by the counting unit, determines whether or not to perform the detection process based on the reception intervals, for at least one burst message among the plurality of burst messages.

As described above, in the detection device that performs the detection process based on the reception intervals of the target messages, whether or not to perform the detection process based on the reception intervals of the burst messages is determined based on the count value of the burst messages. In this configuration, whether or not to use a plurality of burst messages as the targets of the detection process can be determined according to the level of possibility that an unauthorized target message is included in the plurality of burst messages. Therefore, for example, overlooking of the unauthorized message included in the plurality of burst messages can be inhibited while inhibiting erroneous detection due to occurrence of a burst phenomenon. As a result, an abnormality in the network can be detected more accurately.

(2) In the above (1), when the count value is equal to or smaller than a threshold value, the detection unit may not necessarily perform the detection process based on the reception interval of the at least one burst message among the plurality of burst messages.

In this configuration, a plurality of burst messages in which an unauthorized target message is unlikely to be included are excluded from the targets of the detection process, whereby erroneous detection due to occurrence of a burst phenomenon can be inhibited.

(3) According to the above (1) or (2), when the count value is larger than the threshold value, the detection unit may perform the detection process based on the reception intervals of the plurality of burst messages.

In this configuration, without excluding a plurality of burst messages in which an unauthorized target message is likely to be included from the targets of the detection process, the detection process can be performed based on the plurality of burst messages. Therefore, overlooking of the unauthorized message can be inhibited.

(4) According to any one of the above (1) to (3), the detection unit may determine the threshold value according to the reception interval of the target message that is the delay message.

In this configuration, whether or not to perform the detection process based on the reception intervals of the burst messages can be determined more appropriately by using the threshold value determined according to the degree of delay of the delay message.

(5) According to any one of the above (1) to (4), the detection unit may calculate a detection index that increases and decreases according to a relationship between the reception interval and reference information regarding the reception interval, and perform the detection process based on the calculated detection index. When the count value is equal to or smaller than the threshold value, the detection unit may not necessarily perform calculation of the detection index for the at least one burst message among the plurality of burst messages.

In this configuration, an abnormality in the network can be detected more accurately based on the detection index that indicates the degree of deviation of a reception interval of a message from a normal value, while inhibiting erroneous detection due to occurrence of a burst phenomenon.

(6) According to any one of the above (1) to (5), the counting unit may end counting if a next target message is not received within a predetermined time period from a reception time of the target message that is the burst message. The detection unit may suspend the detection process until counting by the counting unit is ended, and resume the detection process after counting by the counting unit is ended.

In this configuration, counting of burst messages can be ended with the end of the burst phenomenon, and the detection process can be resumed at a more appropriate timing.

(7) A detection method according to the embodiment of the present disclosure is a detection method used in a detection device that detects an abnormality in a network in which a plurality of target messages, including a periodic message being transmitted and received in a predetermined transmission cycle, are transmitted and received. The detection method includes: calculating reception intervals of the target messages; performing a detection process of detecting an abnormality in the network, based on the calculated reception intervals; and counting a plurality of burst messages including a delay message that is a target message whose reception interval is larger than the transmission cycle by a predetermined value or more, and one or more target messages which are received subsequently to the delay message and whose reception interval is equal to or smaller than a predetermined value. In performing the detection process, whether or not to perform the detection process based on the reception intervals is determined for at least one burst message among the plurality of burst messages, based on a count value of the plurality of burst messages.

As described above, in the detection device that performs the detection process based on the reception intervals of the target messages, whether or not to perform the detection process based on the reception intervals of the burst messages is determined based on the count value of the burst messages. In this method, whether or not to use a plurality of burst messages as the targets of the detection process can be determined according to the level of possibility that an unauthorized target message is included in the plurality of burst messages. Therefore, for example, overlooking of the unauthorized message included in the plurality of burst messages can be inhibited while inhibiting erroneous detection due to occurrence of a burst phenomenon. As a result, an abnormality in the network can be detected more accurately.

Hereinafter, an embodiment of the present disclosure will be described with reference to the drawings. In the drawings, the same or corresponding parts are denoted by the same reference signs, and description thereof is not repeated. At least some parts of the embodiment described below may be combined as desired.

### [Configuration and Basic Operation]

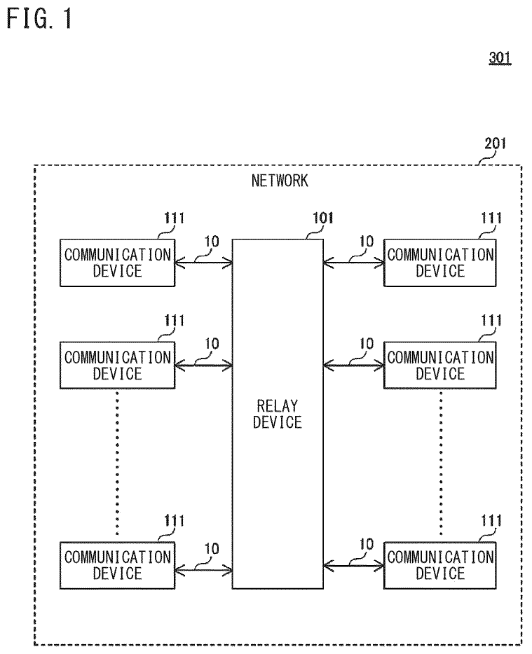

FIG. 1 shows a configuration of a communication system according to the embodiment of the present disclosure. With reference to FIG. 1, a communication system 301 includes a relay device 101 and a plurality of communication devices 111. The communication system 301 is installed in, for example, a vehicle. In this case, each of the communication devices 111 is, for example, an in-vehicle ECU (Electronic Control Unit). The communication system 301 may be configured to include a relay device (not shown) other than the relay device 101.

The relay device 101 and the communication devices 111 constitute a network 201. More specifically, the relay device 101 and each communication device 111 are connected to each other via a transmission line 10. In the communication system 301, the relay device 101 may be connected to each communication device 11l in a one-to-one manner via a linear transmission line 10 as shown in FIG. 1, may be connected to the communication devices 111 via another relay device (not shown) and the transmission lines 10, or may be connected to the communication devices 111 in a one-to-many manner via a bus-type transmission line 10. The transmission line 10 is, for example, a cable conforming to a standard such as CAN (Controller Area Network) (registered trademark), FlexRay (registered trademark), MOST (Media Oriented Systems Transport) (registered trademark), Ethernet, (registered trademark), or LIN (Local Interconnect Network).

The relay device 101 can communicate with the communication devices 111. The relay device 101 performs, for example, a relay process of relaying information that is exchanged between a plurality of communication devices 111 connected to different transmission lines 10.

In the network 201, a plurality of messages, including a message that is periodically transmitted, are transmitted and received.

More specifically, in the network 201, for example, a message is periodically transmitted from a communication device 111 to another communication device 111 via the relay device 101 according to a predetermined rule. Hereinafter, the message that is periodically transmitted in the network 201 is also referred to as a periodic message. The “periodic message” refers not only to a message that is strictly periodically transmitted but also to a kind of message that is to be periodically transmitted.

In the network 201, in addition to the periodic message, a message that is non-periodically transmitted from a communication device 111 to another communication device 111 via the relay device 101 exists. Hereinafter, the message that is non-periodically transmitted in the network 201 is also referred to as an event message.

Transmission of a message by the communication device 111 may be performed by any of broadcast, unicast, and multicast.

The relay device 101 serves as a detection device, and detects an abnormality in the network 201.

### [Relay Device]

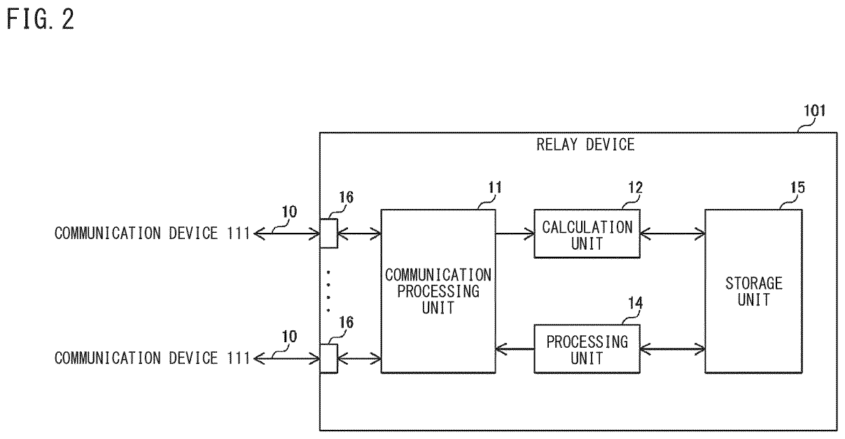

FIG. 2 shows a configuration of a relay device according to the embodiment of the present disclosure. With reference to FIG. 2, the relay device 101 includes a communication processing unit 11, a calculation unit 12, a processing unit 14, a storage unit 15, and a plurality of communication ports 16. The processing unit 14 is an example of a counting unit, and an example of a detection unit. Some or all of the communication processing unit 11, the calculation unit 12, and the processing unit 14 are realized by processing circuitry including one or more processors, for example. The storage unit 15 is, for example, a flash memory included in the processing circuitry. The communication ports 16 are, for example, connectors or terminals. A transmission line 10 is connected to each communication port 16.

The communication processing unit 11 performs a relay process of relaying a message being transmitted between the communication devices 111. For example, upon receiving a message from a communication device 111 via the corresponding transmission line 10 and the corresponding communication port 16, the communication processing unit 11 generates a message CP that is a duplicate of the received message, and adds a time stamp indicating the reception time of the received message to the generated message CP. Then, the communication processing unit 11 transmits the received message to another communication device 111 via the corresponding communication port 16 and the corresponding transmission line 10, and outputs the message CP with the time stamp added, to the calculation unit 12.

### (Calculation of Reception Interval)

The calculation unit 12 calculates reception intervals of target messages that are messages to be subjected to a detection process in the relay device 101. The relay device 101 may be configured to perform the detection process for one kind of message transmitted from a certain communication device 111, or may be configured to perform the detection process for each of plural kinds of messages respectively transmitted from a plurality of communication devices 111. Hereinafter, a case where the relay device 101 performs the detection process for a message transmitted as a “target message M” from a certain communication device 111 will be described. A plurality of target messages M transmitted in the network 201 include a periodic message transmitted from the communication device 111 according to a predetermined transmission cycle Cm.

More specifically, the calculation unit 12 acquires a reception time t of a target message M among messages relayed by the communication processing unit 11.

For example, the storage unit 15 has, stored therein, an ID for each kind of target message. Hereinafter, the ID of a target message is also referred to as a target ID, and the ID of a target message M is also referred to as a target ID_M.

The calculation unit 12 receives a message CP from the communication processing unit 11, and confirms the ID included in the received message CP and the target ID stored in the storage unit 15.

If the ID included in the message CP received from the communication processing unit 11 matches the target ID_M, the calculation unit 12 recognizes that the original message of the message CP is the target message M, and acquires the reception time t of the target message M with reference to the time stamp added to the message CP.

Upon acquiring the reception time t of the target message M, the calculation unit 12 calculates a difference between this reception time t and a reception time t of an immediately preceding target message M, as a reception interval x of the target message M. More specifically, the calculation unit 12 subtracts, from a reception time tm of an m-th target message Mm received by the communication processing unit 11, a reception time t(m−1) of an (m−1)th target message M(m−1) received by the communication processing unit 11 to calculate a reception interval xm of the target message Mm. Here, m is a positive integer. The calculation unit 12 stores the calculated reception interval xm and the reception time tm in the storage unit 15. When there are a plurality of target messages, the calculation unit 12 calculates the reception interval xm and the reception time tm for each target message, and stores the calculated reception interval xm and reception time tm in the storage unit 15 for each target ID.

### (Detection Process)

The processing unit 14 performs a detection process of detecting an abnormality in the network 201, based on the reception interval x calculated by the calculation unit 12.

For example, by using a standard deviation σ of the reception interval x calculated by the calculation unit 12, the processing unit 14 calculates a statistic value T of the reception interval x, and performs the detection process based on the calculated statistic value T. The statistic value T indicates a degree of deviation of the reception interval x from a normal state. The statistic value Tis an example of a detection index.

More specifically, when the reception interval xm of the target message Mm has been stored in the storage unit 15 by the calculation unit 12, the processing unit 14 calculates a degree of abnormality Dm of the target message Mm according to the following formula (1).

$$[ Math . 1 ]$$

$$Tm = max \{ 0 , ( T ( m - 1 ) + Dm - k ) \} \qquad ( 2 )$$

In formula (1), μ is an average value of reception intervals x, and is an example of reference information related to the target message M. The standard deviation σ and the average value u are stored in the storage unit 15. For example, the standard deviation σ is calculated based on the reception interval x by a manufacturer of the communication system 301 in advance, and is stored in the storage unit 15. For example, the average value u is a value calculated based on a design value of a transmission cycle Cm of the target message M in the network 201 by the manufacturer of the communication system 301 in advance, and is stored in the storage unit 15 in advance. The processing unit 14 may periodically or non-periodically calculate a standard deviation σ and an average value μ based on a plurality of reception intervals x corresponding to a plurality of target messages M. and may update the standard deviation σ and the average value u stored in the storage unit 15 to the calculated standard deviation σ and average value u.

With the calculated degree of abnormality Dm of the target message Mm, the processing unit 14 calculates a statistic value Tm of the target message Mm according to the following formula (2).

$$[ Math . 2 ]$$

$$Tm = max \{ 0 , ( T ( m - 1 ) + Dm - k ) \} \qquad ( 2 )$$

In formula (2), k is a limit parameter. The limit parameter k is a constant that is set in advance. As shown in formula (2), the statistic value Tm of the target message Mm is a value which is obtained by subtracting the limit parameter k from the sum of a statistic value T(m−1) of the target message M(m−1) and the degree of abnormality Dm, or zero, whichever is larger.

As shown in formula (1) and formula (2), the statistic value Tm increases and decreases according to the relationship between the reception interval xm of the target message Mm, and the average value u. Specifically, if the degree of abnormality Dm becomes a value larger than the limit parameter k because the reception interval xm greatly deviates from the average value μ, the statistic value Tm of the target message Mm becomes larger than the statistic value T(m−1) of the immediately preceding target message M(m−1). Meanwhile, if the degree of abnormality Dm becomes a value smaller than the limit parameter k because the reception interval xm becomes a value close to the average value p, the statistic value Tm of the target message Mm becomes zero, or a value smaller than the statistic value T(m−1) of the immediately preceding target message M(m−1).

The processing unit 14 performs a detection process of detecting an abnormality in the network 201, based on the calculated statistic value T. For example, the processing unit 14 detects an abnormality in the network 201, based on the calculated statistic value T and a predetermined threshold value Thx.

More specifically, the processing unit 14 compares the calculated statistic value T with the threshold value Thx. If the statistic value T is not larger than the threshold value Thx, the processing unit 14 determines that no abnormality has occurred in the network 201. If the statistic value T is larger than the threshold value Thx, the processing unit 14 determines that an abnormality has occurred in the network 201.

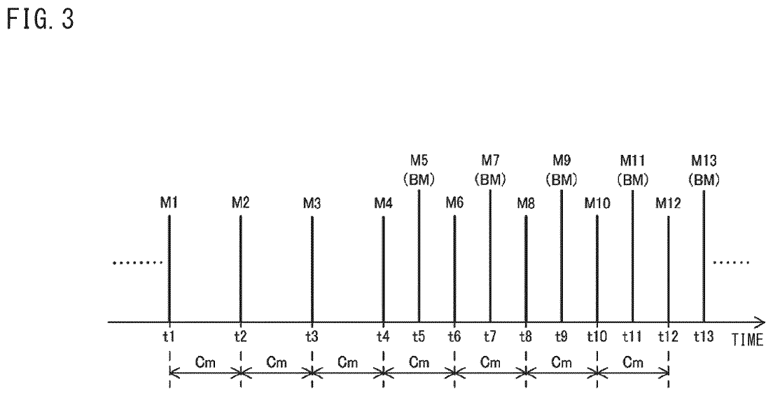

FIG. 3 shows an example of target messages received by the relay device according to the embodiment of the present disclosure, and a distribution of reception times. In FIG. 3, the horizontal axis represents time.

With reference to FIG. 3, a plurality of target messages M received by the communication processing unit 11 include: target messages M1 to M4, M6, M8, M10, M12 which are authorized periodic messages received at timings based on the transmission cycle Cm during a period from a reception time t1 to a reception time t12; and target messages M5, M7, M9, M11, M13 which are unauthorized messages BM received at timings based on the transmission cycle Cm, for example, during a period from a reception time t5 to a reception time t13. That is, during the period from the reception time t5 to the reception time t13, the authorized periodic messages and the unauthorized periodic messages alternately arrive at the relay device 101.

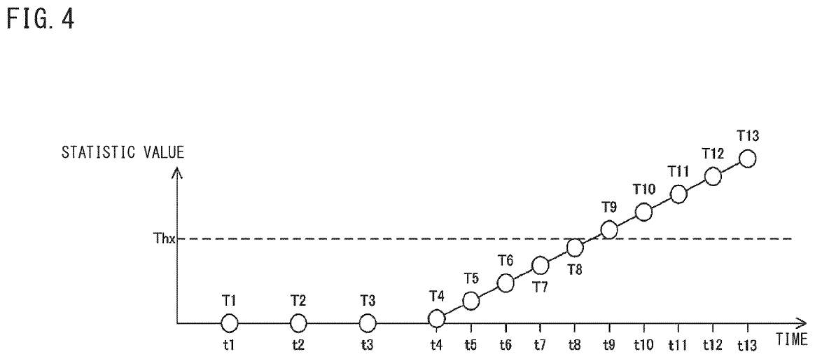

FIG. 4 shows an example of statistic values used for a detection process in the relay device according to the embodiment of the present disclosure. In FIG. 4, the horizontal axis represents time, and the vertical axis represents statistic value. FIG. 4 shows statistic values T1 to T13 which are calculated by the calculation unit 12, based on the reception times t1 to t13 of the target messages M1 to M13 shown in FIG. 3.

With reference to FIG. 4, during a period from the reception time t1 to the reception time t4, only the authorized target messages M1 to M4 transmitted with the constant transmission cycle Cm are received by the communication processing unit 11, and the reception intervals x1 to x4 each have a value approximately equal to the average value u. Therefore, the statistic values T1 to T4 calculated by the processing unit 14 are zero.

Since the calculated statistic values T1 to T4 are not larger than the threshold value Thx, the processing unit 14 determines that no abnormality has occurred in the network 201 during the period from the reception time t1 to the reception time 14.

Meanwhile, in the period from the reception time t5 to the reception time t13, the unauthorized messages BM are received by the communication processing unit 11 in addition to the target messages M6, M8. M10. M12 transmitted with the transmission cycle Cm, and the reception intervals x5 to x13 each have a value deviated from the average value p. Therefore, the statistic values T5 to T13 calculated by the processing unit 14 gradually increase.

Since the calculated statistic value T9 exceeds the threshold value Thx, the processing unit 14 determines that an abnormality has occurred in the network 201 at the reception time t9. Upon determining the occurrence of the abnormality in the network 201, the processing unit 14 transmits warning information indicating the occurrence of the abnormality in the network 201 to a higher-order device located outside the communication system 301 via the communication processing unit 11. The higher-order device is, for example, a device such as a server that performs a predetermined process upon receiving the warning information.

Here, the threshold value Thx can be set to any value by a manufacturer of the network 201. For example, the threshold value Thx being set to a smaller value allows the detection unit 14 to determine occurrence of an abnormality in the network 201 at an earlier timing after transmission of an unauthorized message in the network 201 was started.

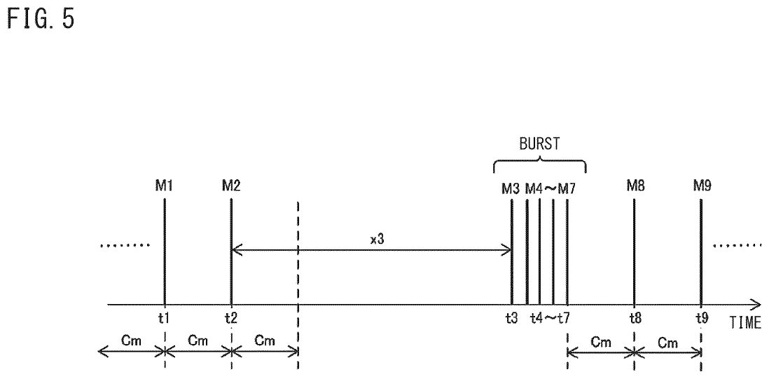

FIG. 5 shows another example of target messages received by the relay device according to the embodiment of the present disclosure, and a distribution of reception times. In FIG. 5, the horizontal axis represents time. FIG. 5 shows distribution of reception times of target messages M1 to M9 which are authorized periodic messages.

With reference to FIG. 5, while the target messages M1, M2 arrive at the relay device 101 with the transmission cycle Cm, the target message M3, which is supposed to normally arrive at the relay device 101 after the transmission cycle Cm from the reception time 12 of the target message M2, may be delayed due to influences such as processing load on the communication device 111 being the transmission source of the target message M, and increase or concentration of traffic in the network 201. In particular, in the network 201 in which the relay device 101 is connected to the plurality of communication devices 111 in a one-to-many manner, arrival of the target message M at the relay device 101 is likely to be delayed due to the transmission-source communication device 111 waiting for the right to access. In the network 201 in which the relay device 101 is connected to the communication devices 111 via another relay device, arrival of the target message M at the relay device 101 is likely to be delayed due to congestion in the other relay device. As shown in FIG. 5, if the target message M3 is delayed, for example, the target messages M4 to M7 following the target message M3 arrive at the relay device 101 with very short intervals due to the delay of the target message M3. Hereinafter, the phenomenon in which a plurality of target messages M arrive at the relay device 101 with short intervals is also referred to as a burst phenomenon.

### [Problems]

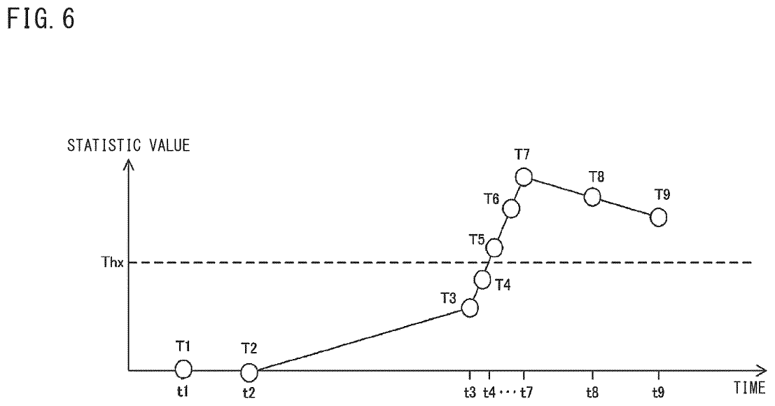

FIG. 6 shows an example of statistic values used for a detection process in a relay device according to a comparative example of the embodiment of the present disclosure. In FIG. 6, the horizontal axis represents time, and the vertical axis represents statistic value. FIG. 6 shows statistic values T1 to T9 calculated by the calculation unit 12 based on the reception times t1 to 19 of the target messages M1 to M9 shown in FIG. 5.

With reference to FIG. 6, if the target message M3 is delayed, the reception interval x3 becomes larger than the average value μ, and therefore the calculated statistic value T3 increases. In addition, since the target messages M4 to M7 arrive at the relay device with very short intervals, the reception intervals x4 to x7 become smaller than the average value u, and therefore the calculated statistic values T4 to T7 gradually increase.

The relay device according to the comparative example determines that an abnormality has occurred in the network 201 because, for example, the statistic value T5 exceeds the threshold value Thx. That is, the relay device of the comparative example determines that an abnormality has occurred in the network 201, when the reception interval x of the target message M is shortened due to the burst phenomenon even through an unauthorized message has not arrived.

In order to inhibit such erroneous detection, it is conceivable that the reception intervals x of the target messages M that have arrived during the period in which the burst phenomenon occurs are excluded from the targets of the detection process. However, in this method, if an unauthorized message arrives during the period in which the burst phenomenon occurs, this unauthorized message cannot be detected.

Therefore, the relay device 101 according to the embodiment of the present disclosure has the following configuration to solve the above problems.

### (Detection of Delay Message DEM)

The processing unit 14 detects a delay message DEM that is a target message M whose reception interval x is larger than the transmission cycle Cm by a predetermined value or more.

More specifically, when a reception interval x and a reception time t of a target message M are stored in the storage unit 15 by the calculation unit 12, the processing unit 14 compares the reception interval x with a predetermined threshold value ThD, and determines whether or not the target message M is a delay message DEM such as, for example, the target message M3 described above. The threshold value ThD is a threshold value used for detecting a delay message DEM, and is, for example, twice the transmission cycle Cm of the periodic message.

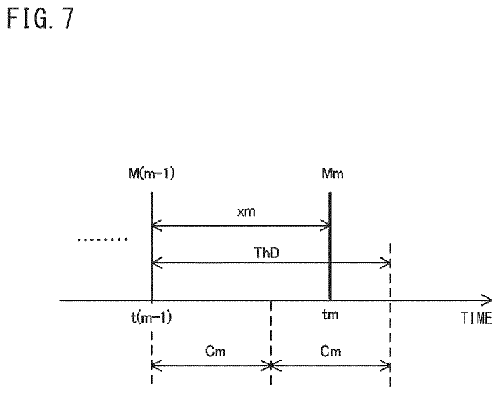

FIG. 7 shows an example of reception times of target messages received by the relay device according to the embodiment of the present disclosure. In FIG. 7, the horizontal axis represents time.

With reference to FIG. 7, when a reception interval xm of a target message Mm is smaller than the threshold value ThD, the processing unit 14 determines that the target message Mm is not a delay message DEM. In this case, the processing unit 14 calculates a statistic value Tm of the reception interval xm. Then, the processing unit 14 compares the calculated statistic value Tm with the threshold value Thx, and determines whether or not an abnormality occurs in the network 201, based on the comparison result.

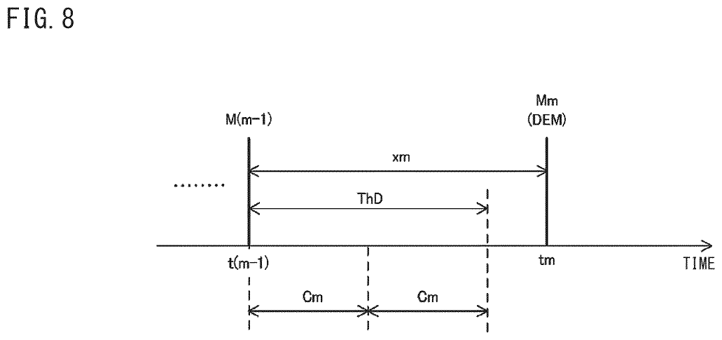

FIG. 8 shows another example of reception times of target messages received by the relay device according to the embodiment of the present disclosure. In FIG. 8, the horizontal axis represents time.

With reference to FIG. 8, when the reception interval xm of the target message Mm is equal to or larger than the threshold value ThD, the processing unit 14 determines that the target message Mm is a delay message DEM. In this case, the processing unit 14 suspends calculation of a statistic value T of the reception interval x of the delay message DEM until a calculation time tB obtained by adding a threshold value ThB to the reception time t of the delay message DEM. That is, the processing unit 14 suspends calculation of a statistic value Tm of the reception interval xm until a calculation time (Bm obtained by adding the threshold value ThB to the reception time tm of the target message Mm being the delay message DEM. Then, the processing unit 14 waits for storage of a reception interval x(m+1) of a target message M(m+1) next to the target message Mm into the storage unit 15 by the calculation unit 12.

For example, the threshold value ThB is set in advance based on an IFG (InterFrame Gap) of frames in which messages are stored. Preferably, the threshold value ThB is a value obtained by adding a predetermined margin, which is set based on a fluctuation in a frame transmission timing, to a frame transmission time according to the minimum IFG. The threshold value ThB may be a value obtained by subtracting a predetermined value from the transmission cycle Cm.

### (Determination of Burst Phenomenon)

Upon detecting a delay message DEM, the processing unit 14 determines whether or not a burst phenomenon has occurred.

More specifically, the processing unit 14 determines whether or not a burst phenomenon has occurred, according to whether or not a new target message M arrives at the relay device 101 before the calculation time tB for the delay message DEM. If a new message other than the target message M has arrived at the relay device 101 before the calculation time tB, the processing unit 14 may update the calculation time tB to a time obtained by adding the threshold value ThB to the reception time of the new message.

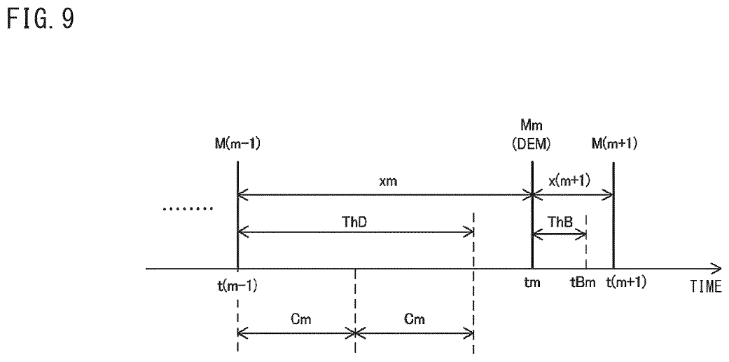

FIG. 9 shows an example of reception times of target messages received by the relay device according to the embodiment of the present disclosure. In FIG. 9, the horizontal axis represents time. FIG. 9 shows a reception time t(m+1) of a target message M(m+1) received by the communication processing unit 11 after the reception time tm shown in FIG. 8.

With reference to FIG. 9, if the calculation time tBm for the target message Mm has arrived before a target message M(m+1) next to the target message Mm being the delay message DEM is received by the communication processing unit 11, the processing unit 14 determines that no burst phenomenon has occurred. That is, if the calculation time tBm has arrived before the reception interval x(m+1) and the reception time t(m+1) of the target message M(m+1) are stored in the storage unit 15 by the calculation unit 12, the processing unit 14 determines that no burst phenomenon has occurred. In this case, the processing unit 14 cancels the above suspension, and calculates a statistic value Tm of the reception interval xm according to the above formula (1) and formula (2). Then, the processing unit 14 compares the calculated statistic value Tm with the threshold value Thx, and determines whether or not an abnormality occurs in the network 201, based on the comparison result.

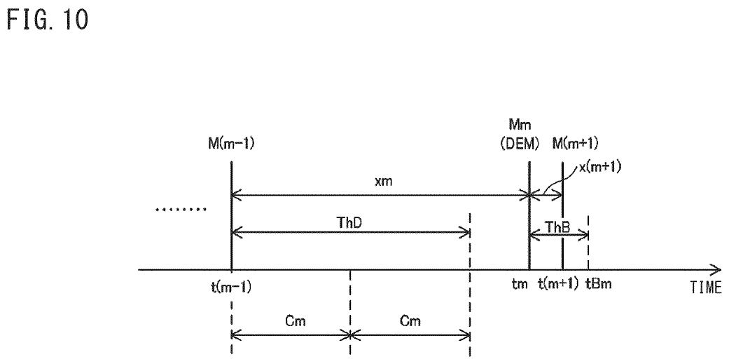

FIG. 10 shows another example of reception times of target messages received by the relay device according to the embodiment of the present disclosure. In FIG. 10, the horizontal axis represents time. FIG. 10 shows a reception time t(m+1) of a target message M(m+1) received by the communication processing unit 11 after the reception time tm shown in FIG. 8.

With reference to FIG. 10, if the target message M(m+1) next to the target message Mm being the delay message DEM is received by the communication processing unit 11 before the calculation time tBm for the target message Mm, the processing unit 14 determines that a burst phenomenon has occurred at the reception time tm of the target message Mm. That is, if the reception interval x(m+1) and the reception time t(m+1) of the target message M(m+1) are stored in the storage unit 15 by the calculation unit 12 before arrival of the calculation time tBm, the processing unit 14 determines that a burst phenomenon has occurred at the reception time tm of the target message Mm.

Upon determining that a burst phenomenon has occurred at the reception time tm of the target message Mm, the processing unit 14 outputs burst occurrence information including the reception time t(m+1) of the target message M(m+1) to the calculation unit 12. Upon receiving the burst occurrence information from the processing unit 14, the calculation unit 12 determines whether or not the burst phenomenon has ended, based on an end determination time tE obtained by adding the threshold value ThB to the reception time t of the target message M.

More specifically, if a target message M(m+q+2) next to a target message M(m+q+1) is received by the communication processing unit 11 before an end determination time tE(m+q+1) for the target message M(m+q+1) and after the reception time t(m+1) indicated by the received burst occurrence information, the calculation unit 12 determines that the burst phenomenon continues. That is, if a message CP including a timestamp indicating a reception time t(m+q+2) is outputted by the communication processing unit 11 before arrival of the end determination time tE(m+q+1), the calculation unit 12 determines that the burst phenomenon continues. Here, q is a positive integer.

Meanwhile, if the end determination time tE(m+q+1) for the target message M(m+q+1) has arrived before the target message M(m+q+2) next to the target message M(m+q+1) is received by the communication processing unit 11 and after the reception time t(m+1) indicated by the received burst occurrence information, the calculation unit 12 determines that the burst phenomenon has ended. That is, if the end determination time tE(m+q+1) has arrived before the message CP including the timestamp indicating the reception time t(m+q+2) is outputted by the communication processing unit 11, the calculation unit 12 determines that the burst phenomenon has ended. Upon determining the end of the burst phenomenon, the calculation unit 12 outputs burst end information to the processing unit 14.

If a new message other than the target message M has arrived at the relay device 101 before the end determination time tE, the calculation unit 12 may update the end determination time tE to a time obtained by adding the threshold value ThB to the reception time of the new message. That is, after the reception time t(m+1) indicated by the burst occurrence information, each time the calculation unit 12 receives a message CP from the communication processing unit 11, the calculation unit 12 may update the end determination time tE based on the timestamp included in the message CP, regardless of the ID included in the received message CP. If the communication processing unit 11 does not output a next message CP before arrival of the end determination time tE, the calculation unit 12 may determine that the burst phenomenon has ended.

### (Counting of Burst Messages)

The processing unit 14 counts a plurality of burst messages Mbst including a detected delay message DEM, and one or more target messages M which are received subsequently to the delay message DEM and whose reception interval x is equal to or smaller than the threshold value ThB. That is, the processing unit 14 counts, as the burst messages Mbst, a plurality of target messages M which are successively received by the communication processing unit 11, and include the target message M being the delay message DEM, and one or more target messages M which are received subsequent to the target message M and whose reception interval x is equal to or smaller than the threshold value ThB.

For example, the processing unit 14 counts burst messages Mbst which are target messages M received by the communication processing unit 11 during a period in which the burst phenomenon occurs.

More specifically, upon determining that a burst phenomenon has occurred at the reception time tm of the target message Mm, based on the result of comparison between the reception interval x(m+1) and the threshold value ThB, the processing unit 14 determines that the target message Mm is the first burst message Mbst and the target message M(m+1) is the second burst message Mbst. and holds “2” as a count value CNT of the burst messages Mbst.

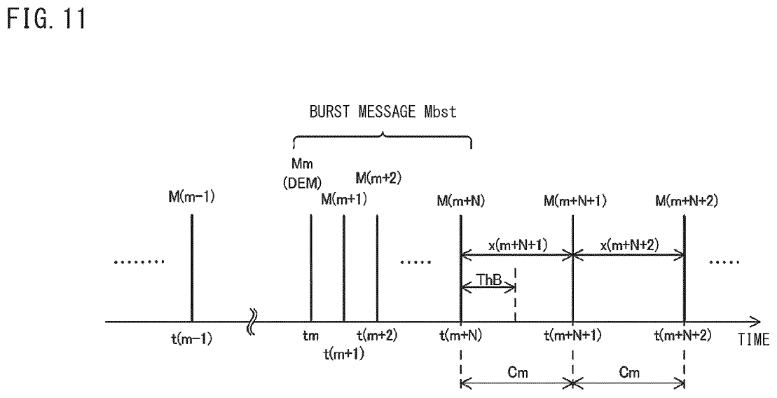

FIG. 11 shows an example of reception times of target messages received by the relay device according to the embodiment of the present disclosure. In FIG. 11, the horizontal axis represents time. FIG. 11 shows reception times t of a plurality of target messages M received by the communication processing unit 11 after the reception time tm shown in FIG. 10.

With reference to FIG. 11, after determining that a burst phenomenon has occurred, the processing unit 14 increments and updates the count value CNT each time a reception interval x(m+n) and a reception time t(m+n) of a target message M(m+n) are stored in the storage unit 15 by the calculation unit 12. Here, n is an integer not less than 2.

More specifically, when a reception interval x(m+2) and a reception time t(m+2) of a target message M(m+2) are stored in the storage unit 15 by the calculation unit 12, the processing unit 14 updates the count value CNT to “3”.

Likewise, when a reception interval x(m+N) and a reception time t(m+N) of a target message M(m+N) are stored in the storage unit 15 by the calculation unit 12, the processing unit 14 updates the count value CNT to “N+1”.

For example, if a next target message M is not received by the communication processing unit 11 within a predetermined time from the reception time t of the target message M being the burst message Mbst, the processing unit 14 ends counting. More specifically, upon receiving the burst end information from the calculation unit 12, the processing unit 14 ends counting of the burst messages Mbst.

### (Restrictions on Use of Burst Message Reception Intervals)

The processing unit 14, based on the count value CNT, determines whether or not to perform a detection process based on reception intervals x of a plurality of burst messages Mbst.

For example, when the count value CNT is equal to or smaller than a threshold value ThC, the processing unit 14 does not perform a detection process based on the reception interval x of at least one burst message Mbst among a plurality of burst messages Mbst. Specifically, when the count value CNT is equal to or smaller than the threshold value ThC, the processing unit 14 restricts use, in the detection process, of the reception interval x of at least one burst message Mbst among the plurality of burst messages Mbst. More specifically, when counting of the burst messages Mbst has been ended, the processing unit 14 compares the count value CNT with the threshold value ThC. When the count value CNT is equal to or smaller than the threshold value ThC, the processing unit 14 discards the reception intervals x of all the burst messages Mbst without using them for the detection process.

For example, the processing unit 14 determines the threshold value ThC to be used for comparison with the count value CNT, according to the reception interval x of the target message M being the delay message DEM.

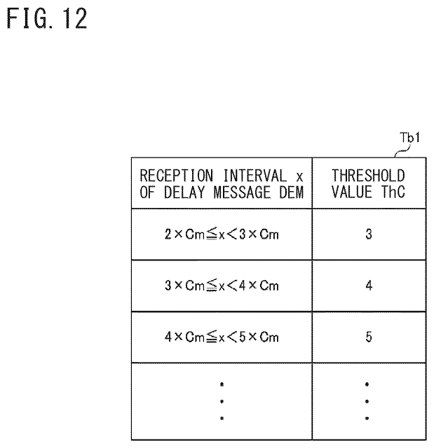

FIG. 12 shows an example of a correspondence table stored in the storage unit in the relay device according to the embodiment of the present disclosure. With reference to FIG. 12, the storage unit 15 has, stored therein, a correspondence table Tb1 showing the correspondence between the reception interval x of the delay message DEM and the threshold value ThC. For example, in the correspondence table Tb1, when it is assumed that the target message M arrives at the relay device 101 at a timing according to the transmission cycle Cm, the threshold value ThC is set to a value obtained by adding a predetermined margin to the number of target messages M received by the communication processing unit 11 during a period from the reception time t of the target message M immediately preceding the delay message DEM to the reception time t of the delay message DEM.

For example, the processing unit 14 acquires, from the correspondence table Tb1 stored in the storage unit 15, the threshold value ThC corresponding to the reception interval xm of the target message Mm determined to be the delay message DEM. As an example, when the reception interval xm of the target message Mm determined to be the delay message DEM is four times or more the transmission cycle Cm and less than five times the transmission cycle Cm, the processing unit 14 acquires “5” as the threshold value ThC.

Referring back to FIG. 11, the processing unit 14 compares the acquired threshold value ThC with the count value CNT, and when the count value CNT is equal to or smaller than the threshold value ThC, discards the reception intervals xm, x(m+1), . . . , x(m+N) of the target messages Mm, M(m+1), . . . , M(m+N) being burst messages Most without using them for the detection process.

More specifically, when the count value CNT is equal to or smaller than the threshold value ThC, calculation of statistic values T for the burst messages Mbst is not performed. That is, the processing unit 14 deletes the reception intervals xm, x(m+1), . . . , x(m+N) from the storage unit 15 without calculating statistic values Tm, T(m+1), . . . , T(m+N) of the reception intervals xm, x(m+1), . . . , x(m+N).

When the count value CNT is equal to or smaller than the threshold value ThC, it is unlikely that an unauthorized message is included in the plurality of burst messages Mbst received by the communication processing unit 11. Therefore, by discarding the reception intervals x of the burst messages Mbst without using them for the detection process, erroneous detection due to occurrence of a burst phenomenon can be inhibited.

For example, upon determining that a burst phenomenon has occurred, the processing unit 14 suspends the detection process until counting of burst messages Mbst is ended, and resumes the detection process after counting of burst messages Mbst is ended.

More specifically, when a reception interval x(m+N+1) of a target message M(m+N+1) is larger than the threshold value ThB and smaller than the threshold value ThD, the processing unit 14 determines that the burst phenomenon is ended at the reception time t(m+N) of the target message M(m+N) and that the target message M(m+N+1) is not a delay message DEM, and calculates a statistic value T(m+N+1) of the reception interval x(m+N+1). More specifically, the processing unit 14 calculates the statistic value T(m+N+1) according to the above formula (1) by using the statistic value T(m−1) of the target message M(m−1) immediately preceding the burst messages Most, instead of a statistic value T(m+N) of a reception interval x(m+N).

Then, the processing unit 14 compares the calculated statistic value T(m+N+1) with the threshold value Thx, and determines whether or not an abnormality occurs in the network 201, based on the comparison result.

Next, when a reception interval x(m+N+2) of a target message M(m+N+2) is stored in the storage unit 15 by the calculation unit 12 and the reception interval x(m+N+2) is smaller than the threshold value ThD, the processing unit 14 determines that the target message M(m+N+2) is not a delay message DEM, and calculates a statistic value T(m+N+2) of the reception interval x(m+N+2).

Then, the processing unit 14 compares the calculated statistic value T(m+N+2) with the threshold value Thx. and determines whether or not an abnormality occurs in the network 201, based on the comparison result.

Upon determining that the burst phenomenon has ended at the reception time t(m+N) of the target message M(m+N), the processing unit 14 may delete the reception interval x(m+N+1) from the storage unit 15 without calculating the statistic value T(m+N+1) of the reception interval x(m+N+1). In this case, the processing unit 14 waits for storage of the reception interval x(m+N+2) into the storage unit 15 by the calculation unit 12, and calculates the statistic value T(m+N+2) according to the above formula (1) by using the statistic value T(m−1) of the target message M(m−1) immediately preceding the burst messages Mbst, instead of the statistic value T(m+N+1) of the reception interval x(m+N+1).

### (Detection Process Using Reception Intervals of Burst Messages)

When the count value CNT is larger than the threshold value ThC, the processing unit 14 performs a detection process based on the reception intervals x of the burst messages Mbst.

More specifically, the processing unit 14 compares the threshold value ThC with the count value CNT, and when the count value CNT is larger than the threshold value ThC, calculates statistic values Tm, T(m+1), . . . , T(m+N) of the reception intervals xm, x(m+1), . . . , x(m+N) of the target messages Mm, M(m+1), . . . , M(m+N) being burst messages Mbst. Then, the processing unit 14 compares the calculated statistic values Tm, T(m+1), . . . , T(m+N) with the threshold value Thx, and determines whether or not an abnormality occurs in the network 201, based on the comparison result.

When the count value CNT is larger than the threshold value ThC, it is likely that an unauthorized message is included in the plurality of burst messages Mbst received by the communication processing unit 11. Therefore, by performing the detection process as usual based on the reception intervals x of the burst messages Most, overlooking of the unauthorized message can be inhibited.

### <Modifications>

The processing unit 14 calculates a statistic value T of a reception interval x, and performs a detection process based on the calculated statistic value T. However, the present disclosure is not limited thereto. The processing unit 14 may perform the detection process without calculating the statistic value T. As an example, the processing unit 14 calculates a moving average value A of reception intervals x of latest p target messages M received by the communication processing unit 11, and performs the detection process based on the calculated moving average value A. Here, p is an integer not smaller than 2. The moving average value A is an example of a detection index.

More specifically, the processing unit 14 calculates a reception interval xm of a target message Mm, and calculates a moving average value Am of reception intervals xm, x(m−1), x(m−2), . . . , x(m−p+1). Here, the reception intervals x(m−1), x(m−2), . . . , x(m−p+1) are an example of reference information regarding the target message M. Hereinafter, the reception intervals x(m−1), x(m−2), . . . , x(m−p+1) are also referred to as reference intervals rm. The moving average value Am increases and decreases according to the relationship between the reception interval xm of the target message Mm and the reference intervals rm.

For example, when the plurality of target messages M received by the communication processing unit 11 include unauthorized messages BM as shown in FIG. 3, the moving average value A calculated by the processing unit 14 gradually decreases during a period from the reception time 15 to the reception time t13.

The processing unit 14 detects an abnormality in the network 201, based on the calculated moving average value A and a predetermined threshold value Thy. More specifically, the processing unit 14 compares the calculated moving average value A with the threshold value Thy. When the moving average value A is equal to or larger than the threshold value Thy, the processing unit 14 determines that no abnormality occurs in the network 201. Meanwhile, when the moving average value A is smaller than the threshold value Thy, the processing unit 14 determines that an abnormality occurs in the network 201.

When the count value CNT of the burst messages Mbst is equal to or smaller than the threshold value ThC, the processing unit 14 discards the reception intervals x of the burst messages Mbst without using them for calculation of a moving average value A. Then, when the reception interval x of the target message M received next to the burst messages Mbst is equal to or larger than a predetermined value, the processing unit 14 calculates a moving average value A of reception intervals x of latest p target messages M received by the communication processing unit 11, excluding the burst messages Most, and performs the detection process based on the calculated moving average value A.

### [Operation Flow]

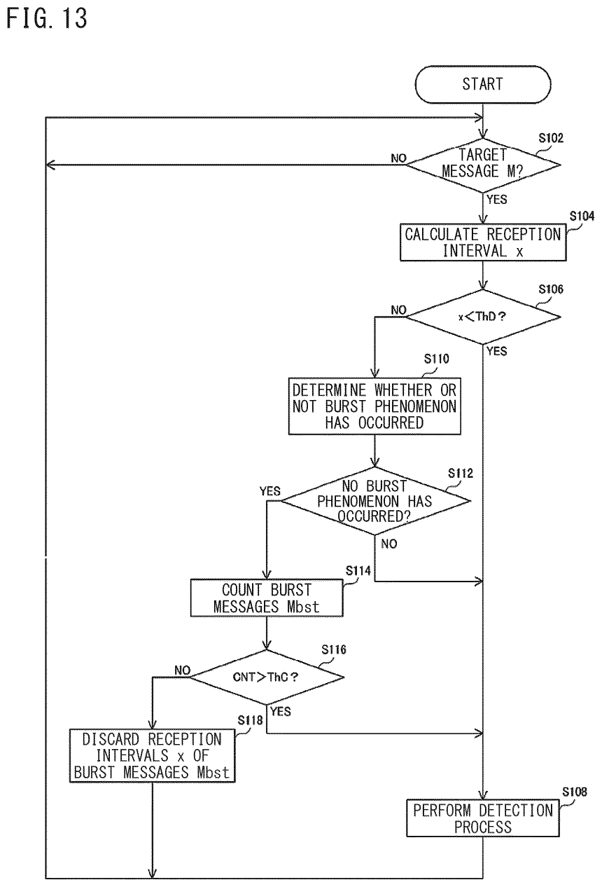

FIG. 13 is a flowchart showing an example of an operation procedure when the relay device according to the present disclosure performs a detection process.

With reference to FIG. 13, first, the relay device 101 waits for arrival of a target message M (NO in step S102). Upon receiving a target message M (YES in step S102), the relay device 101 calculates a reception interval x of the received target message M (step S104).

Next, when the calculated reception interval x is smaller than the threshold value ThD (YES in step S106), the relay device 101 determines that the received target message M is not a delay message DEM, and performs the detection process based on the calculated reception interval x. More specifically, the relay device 101 calculates a statistic value T of the reception interval x, compares the calculated statistic value T with the threshold value Thx, and determines whether or not an abnormality occurs in the network 201, based on the comparison result. Upon determining in the detection process that an abnormality has occurred in the network 201, the relay device 101 transmits, for example, warning information to a higher-order device outside the communication system 301 (step S108).

Next, the relay device 101 waits for arrival of a new target message M (NO in step S102).

Meanwhile, when the calculated reception interval x is equal to or larger than the threshold value ThD (NO in step S106), the relay device 101 determines that the received target message M is a delay message DEM, and determines whether or not a burst phenomenon has occurred. More specifically, the relay device 101 waits for arrival of a target message M next to the delay message DEM or arrival of a calculation time tB regarding the delay message DEM. If the target message M next to the delay message DEM is received before arrival of the calculation time tB, the relay device 101 determines that a burst phenomenon has occurred. If the calculation time tB arrives before arrival of the target message M next to the delay message DEM, the relay device 101 determines that no burst phenomenon has occurred (step S110).

Next, upon determining that no burst phenomenon has occurred (NO in step S112), the relay delay 101 performs the detection process. More specifically, the relay device 101 calculates a statistic value T of the reception interval x of the delay message DEM, and a statistic value T of the reception interval x of the target message M next to the delay message DEM, compares each of the calculated statistic values T with the threshold value Thx, and determines whether or not an abnormality occurs in the network 201, based on the comparison result (step S108).

Next, the relay device 101 waits for arrival of a new target message M (NO in step S102).

Meanwhile, upon determining that a burst phenomenon has occurred (YES in step S112), the relay device 101 counts burst messages Mbst. More specifically, the relay device 101 waits for a new target message M, and counts the burst messages Mbst that are target messages M received during the period in which the burst phenomenon occurs (step S114).

Next, when the count value CNT of the burst messages Mbst is larger than the threshold value ThC (YES in step S116), the relay device 101 performs the detection process based on the reception intervals x of the burst messages Mbst. More specifically, the relay device 101 calculates statistic values T of the reception intervals x of the burst messages Mbst, compares each of the calculated statistic values T with the threshold value Thx, and determines whether or not an abnormality occurs in the network 201, based on the comparison result (step S108).

Next, the relay device 101 waits for arrival of a new target message M (NO in step S102).

Meanwhile, when the count value CNT of the burst messages Mbst is equal to or smaller than the threshold value ThC (NO in step S116), the relay device 101 discards the reception intervals x of the burst messages Mbst (step S118).

Next, the relay device 101 waits for arrival of a new target message M (NO in step S102).

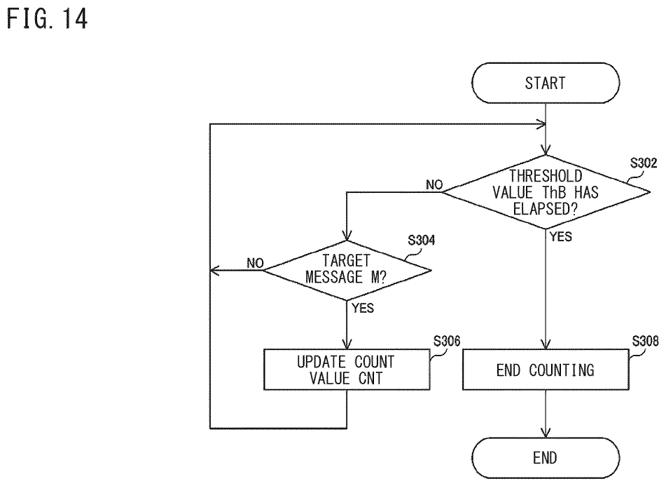

FIG. 14 is a flowchart showing an example of an operation procedure when the relay device according to the embodiment of the present disclosure performs a burst message counting process. FIG. 14 shows details of step S114 in FIG. 13.

With reference to FIG. 14, first, the relay device 101 waits for elapse of the threshold value ThB from the reception time t of the burst message Mbst, and reception of a new target message M (NO in step S302, and NO in step S304). If a new target message M is received before the threshold value ThB elapses from the reception time t of the burst message Mbst (NO in step S302, and YES in step S304), the relay device 101 determines that the received target message M is a burst messages Mbst, and increments and updates the count value CNT (step S306).

Meanwhile, if the threshold value ThB has elapsed from the reception time t of the burst message Mbst before reception of a new target message M (YES in step S302, and NO in step S304), the relay device 101 determines that the burst phenomenon has ended, and ends counting of the burst messages Mbst (step S308).

In the communication system 301 according to the embodiment of the present disclosure, the relay device 101 detects an abnormality in the network 201. However, the present disclosure is not limited thereto. In the communication system 301, a device other than the relay device 101 may serve as a detection device to detect an abnormality in the network 201. For example, the communication system 301 includes a detection device connected to the relay device 101 via the transmission line 10. Upon receiving a message from the communication device 111, the relay device 101 transmits a mirror message, which is a duplicate of the received message, to the detection device via the transmission line 10. The detection device performs calculation of a reception interval x and a detection process, based on a reception time, in the relay device 101, of the mirror message received from the relay device 101.

In the communication system 301 according to the embodiment of the present disclosure, the relay device 101 that serves as a detection device is directly connected to the transmission line 10. However, the present disclosure is not limited thereto.

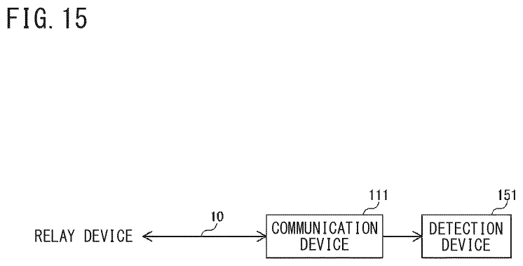

FIG. 15 shows an example of a connection topology of a network according to the embodiment of the present disclosure. With reference to FIG. 15, a detection device 151 may be connected to the transmission line 10 via the communication device 111. In this case, for example, the detection device 151 detects an abnormality in the network 201 by monitoring a message received by the communication device 111. More specifically, the communication device 111 outputs the received message to the detection device 151. The detection device 151 includes a calculation unit 12, a processing unit 14, and a storage unit 15. The calculation unit 12 in the detection device 151 acquires a reception time t of a target message M received by the communication device 111, and calculates a reception interval x based on the acquired reception time t.

In the relay device 101 according to the embodiment of the present disclosure, the storage unit 15 has the correspondence table Tb1 stored therein. However, the present disclosure is not limited thereto.

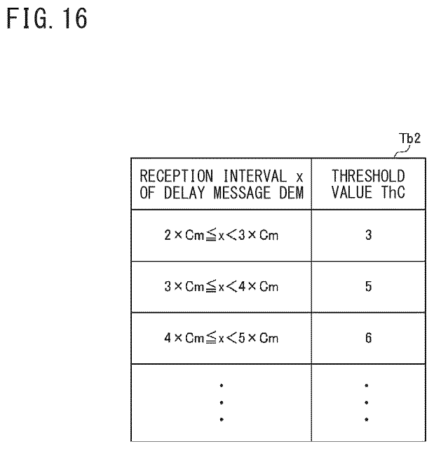

FIG. 16 shows another example of a correspondence table stored in the storage unit in the relay device according to the embodiment of the present disclosure. With reference to FIG. 16, the storage unit 15 may have, stored therein, a correspondence table Tb2 indicating the correspondence between the reception interval x of the delay message DEM and the threshold value ThC, instead of or in addition to the correspondence table Tb1. For example, in the correspondence table Tb2, when it is assumed that the target message M arrives at the relay device 101 at a timing according to the transmission cycle Cm, the threshold value ThC is set to a value obtained by adding; the number of target messages M received by the communication processing unit 11 during a period from the reception time t of the target message M immediately preceding the delay message DEM to the reception time t of the delay message DEM; the number of event messages supposed to be received by the communication processing unit 11, based on event occurrence frequency during this period; and a predetermined margin.

The storage unit 15 may not necessarily have the correspondence tables Tb1, Tb2 stored therein. In this case, the processing unit 14 calculates, by using a predetermined calculation formula, a reception interval x of a target message M determined to be a delay message DEM, and a threshold value ThC based on the transmission cycle Cm.

In the relay device 101 according to the embodiment of the present disclosure, when the count value CNT is equal to or smaller than the threshold value ThC, the processing unit 14 discards the reception intervals x of all the burst messages Mbst without using them for the detection process. However, the present disclosure is not limited thereto. The processing unit 14 may discard the reception intervals x of some of the burst messages Mbst, while using the reception intervals x of the remaining burst messages Mbst for the detection process. For example, the processing unit 14 uses the reception interval x of the delay message DEM among the burst messages Most for the detection process, while discarding the reception intervals x of one or more burst messages Mbst excluding the delay message DEM.

In the relay device 101 according to the embodiment of the present disclosure, when the count value CNT is larger than the threshold value ThC, the processing unit 14 performs the detection process based on the reception intervals x of the burst messages Mbst. However, the present disclosure is not limited thereto. When the count value CNT is larger than the threshold value ThC, the processing unit 14 may not necessarily perform the detection process based on the reception intervals x of the burst messages Mbst. For example, when the count value CNT is larger than the threshold value ThC, the processing unit 14 may determine that an abnormality occurs in the network 201 without performing the detection process.

In the relay device 101 according to the embodiment of the present disclosure, the processing unit 14 determines the threshold value ThC to be compared with the count value CNT, according to the reception interval x of the target message M being a delay message DEM. However, the present disclosure is not limited thereto. The processing unit 14 may use a predetermined threshold value ThC for comparison with the count value CNT, regardless of the reception interval x of the target message M being a delay message DEM.

In the relay device 101 according to the embodiment of the present disclosure, upon determining that a burst phenomenon has occurred, the processing unit 14 suspends the detection process until counting of burst messages Mbst is ended, and resumes the detection process after counting of burst messages Mbst is ended. However, the present disclosure is not limited thereto. The processing unit 14 may perform the detection process afterward, based on a predetermined number of reception intervals x accumulated in the storage unit 15 by the calculation unit 12. When the processing unit 14 performs the detection process afterward, the processing unit 14 may not necessarily perform suspension and resumption of the detection process. More specifically, based on the result of comparison between the count value CNT and the threshold value ThC, the processing unit 14 discards some of the reception intervals x, of the burst messages Mbst, stored in the storage unit 15, and performs the detection process based on the remaining reception intervals x.

In the relay device 101 according to the embodiment of the present disclosure, the processing unit 14 ends counting of the burst messages Mbst upon receiving the burst end information from the calculation unit 12. However, the present disclosure is not limited thereto. The processing unit 14 may determine that the burst phenomenon has ended, based on the result of comparison between the reception interval x and the threshold value ThB, and end the counting. More specifically, when the reception interval x(m+N+1) of the target message M(m+N+1) is larger than the threshold value ThB, the processing unit 14 determines that the burst phenomenon has ended at the reception time t(m+N) of the target message M(m+N), and ends counting of the burst messages DM.

Incidentally, a technology capable of more accurately detecting an abnormality in a network is desired.

In response to such desire, in the relay device 101 according to the embodiment of the present disclosure, the calculation unit 12 calculates a reception interval x of a target message M. The processing unit 14 performs a detection process of detecting an abnormality in the network 201, based on the reception interval x calculated by the calculation unit 12. The processing unit 14 counts a plurality of burst messages Mbst including: a delay message DEM that is a target message M whose reception interval x is larger than a transmission cycle Cm by a predetermined value or more; and one or more target messages M whose reception interval x is equal to or smaller than a predetermined value and which is received subsequently to the delay message DEM. The processing unit 14 determines whether or not to perform a detection process based on the reception interval x, for at least one burst message Mbst among the plurality of burst messages Mbst, based on a count value CNT of the burst messages Mbst.

As described above, in the relay device 101 that performs the detection process based on the reception interval x of the target message M, use of the reception intervals x of the burst messages Mbst in the detection process is restricted based on the count value CNT of the burst messages Mbst. In this configuration, for example, a plurality of burst messages Mbst in which an unauthorized target message M is unlikely to be included are excluded from the targets of the detection process, whereby erroneous detection due to occurrence of a burst phenomenon can be inhibited. Therefore, an abnormality in the network 201 can be detected more accurately.

The above embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

The processes (functions) of the above-described embodiment may be realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network. Alternatively, the program may be distributed in a state of being stored in a recording medium such as a CD-ROM (Compact Disc Read Only Memory), a DVD-ROM (Digital Versatile Disk Read Only Memory), or a semiconductor memory, and may be installed in the memory from the recording medium.

The above description includes the features in the additional notes below.

### Additional Note 1

A detection device that detects an abnormality in a network in which a plurality of target messages, including a periodic message being transmitted and received in a predetermined transmission cycle, are transmitted and received, the detection device comprising:
a calculation unit configured to calculate reception intervals of the target messages;
a detection unit configured to perform a detection process of detecting an abnormality in the network, based on the reception intervals calculated by the calculation unit; and
a counting unit configured to detect a delay message that is a target message whose reception interval is larger than the transmission cycle by a predetermined value or more, and count a plurality of burst messages including the delay message, and one or more target messages which are received subsequently to the delay message and whose reception interval is equal to or smaller than a predetermined value, wherein
the detection unit, based on a count value obtained by the counting unit, determines whether or not to perform the detection process based on the reception intervals, for at least one burst message among the plurality of burst messages, and
when the count value obtained by the counting unit is equal to or smaller than a threshold value, the detection unit discards the reception intervals of the plurality of burst messages, and when the count value is larger than the threshold value, the detection unit performs the detection process based on the reception intervals of the plurality of burst messages.

### Additional Note 2

A detection device that detects an abnormality in a network in which a plurality of target messages, including a periodic message being transmitted and received in a predetermined transmission cycle, are transmitted and received,
the detection device including processing circuitry.
the processing circuitry:
calculating reception intervals of the target messages;
performing a detection process of detecting an abnormality in the network, based on the calculated reception intervals:
detecting a delay message that is a target message whose reception interval is larger than the transmission cycle by a predetermined value or more, and counting a plurality of burst messages including the delay message, and one or more target messages which are received subsequently to the delay message and whose reception interval is equal to or smaller than a predetermined value; and
determining, based on a count value, whether or not to perform the detection process based on the reception intervals, for at least one burst message among the plurality of burst messages.

### REFERENCE SIGNS LIST

10 transmission line
11 communication processing unit
12 calculation unit
14 processing unit (counting unit, detection unit)
15 storage unit
16 communication port
101 relay device
111 communication device
151 detection device
201 network
301 communication system
Tb1, Tb2 correspondence table

1. A detection device that detects an abnormality in a network in which a plurality of target messages, including a periodic message being transmitted and received in a predetermined transmission cycle, are transmitted and received, the detection device comprising:
a calculation unit configured to calculate reception intervals of the target messages;
a detection unit configured to perform a detection process of detecting an abnormality in the network, based on the reception intervals calculated by the calculation unit; and
a counting unit configured to count a plurality of burst messages including a delay message that is a target message whose reception interval is larger than the transmission cycle by a predetermined value or more, and one or more target messages which are received subsequently to the delay message and whose reception interval is equal to or smaller than a predetermined value, wherein
the detection unit, based on a count value obtained by the counting unit, determines whether or not to perform the detection process based on the reception intervals, for at least one burst message among the plurality of burst messages.

2. The detection device according to claim 1, wherein
when the count value is equal to or smaller than a threshold value, the detection unit does not perform the detection process based on the reception interval of the at least one burst message among the plurality of burst messages.

3. The detection device according to claim 1, wherein
when the count value is larger than the threshold value, the detection unit performs the detection process based on the reception intervals of the plurality of burst messages.

4. The detection device according to claim 1, wherein
the detection unit determines the threshold value according to the reception interval of the target message that is the delay message.

5. The detection device according to claim 1, wherein
the detection unit calculates a detection index that increases and decreases according to a relationship between the reception interval and reference information regarding the reception interval, and performs the detection process based on the calculated detection index, and
when the count value is equal to or smaller than the threshold value, the detection unit does not perform calculation of the detection index for the at least one burst message among the plurality of burst messages.

6. The detection device according to claim 1, wherein
the counting unit ends counting if a next target message is not received within a predetermined time period from a reception time of the target message that is the burst message, and
the detection unit suspends the detection process until counting by the counting unit is ended, and resumes the detection process after counting by the counting unit is ended.

7. A detection method used in a detection device that detects an abnormality in a network in which a plurality of target messages, including a periodic message being transmitted and received in a predetermined transmission cycle, are transmitted and received, the detection method comprising:
calculating reception intervals of the target messages;
performing a detection process of detecting an abnormality in the network, based on the calculated reception intervals; and
counting a plurality of burst messages including a delay message that is a target message whose reception interval is larger than the transmission cycle by a predetermined value or more, and one or more target messages which are received subsequently to the delay message and whose reception interval is equal to or smaller than a predetermined value, wherein
in performing the detection process, whether or not to perform the detection process based on the reception intervals is determined for at least one burst message among the plurality of burst messages, based on a count value of the plurality of burst messages.
